(19) United States
(12) Patent Application Publication
(10) Pub. No.: US 2025/0097748 A1
(43) Pub. Date: Mar. 20, 2025

(54) SYSTEMS AND METHODS TO IMPROVE NETWORK SLICE PERFORMANCE AND EFFICIENCY

(71) Applicant: Verizon Patent and Licensing Inc., Basking Ridge, NJ (US)

(72) Inventors: Deepak Majjiga, Irving, TX (US); Ayman Ahmed, Plano, TX (US); Jin Yang, Orinda, CA (US)

(21) Appl. No.: 18/467,358

(22) Filed: Sep. 14, 2023

(51) Int. Cl. H04W 24/10; H04W 48/16; H04W 48/18

(52) U.S. Cl. CPC H04W 24/10; H04W 48/16; H04W 48/18

(57) ABSTRACT

Systems and methods described herein provide new parameters for RAN configurations to manage network slices. A network device stores definitions for multiple mode parameters for a central unit (CU) of a radio access network (RAN), wherein each mode parameter defines a section of the CU that provides a relative performance level for a slice subnet over the RAN. The network device receives a slice configuration request for a network slice that identifies one of the multiple mode parameters and instantiates the network slice to operate over the section of the CU that is associated with the identified one of the multiple mode parameters. Additionally, a slice anti-affinity (SA) parameter is provided to selectively isolate network slices and improve slice reliability within the RAN.

### BACKGROUND

New cellular networks (e.g., Fifth Generation (5G) networks) can provide various services and applications, to user devices, with optimized latency and quality of service. Development and design of such networks present certain challenges from a network-side perspective and an end device perspective. For example, Centralized Radio Access Network (C-RAN) and Open Radio Access Network (O-RAN) architectures have been proposed to satisfy the increasing complexity, densification, and demands of end device application services of a future generation network.

Network Slicing is a type of virtualized networking architecture for 5G networks. Network slicing involves partitioning of a single physical network into multiple virtual networks. The partitions, or “slices,” of the virtualized network may be customized to meet the specific needs of applications, services, devices, customers, or operators. Each network slice can have its own architecture, provisioning management, and security that supports a particular application or service. Speed, capacity, and connectivity functions are allocated within each network slice to meet the requirements of the objective of the particular network slice.

### BRIEF DESCRIPTION OF THE DRAWINGS

FIG. 1 is a diagram illustrating an exemplary base station structure in a portion of a radio access network (RAN);

FIG. 2 is a diagram illustrating an exemplary environment in which embodiments may be implemented;

FIG. 3 is a table illustrating an example of different mode groupings and modes that may be applied to a central unit (CU);

FIG. 4 is a table illustrating example associations of network slices to a mode;

FIGS. 5A-5C are diagrams illustrating application of different modes to a network slice in CU;

FIG. 6 is a flow diagram illustrating an exemplary process for configuring a CU, according to an implementation described herein;

FIG. 7 is a flow diagram illustrating an exemplary process for instantiating a network slice using mode designations in a RAN subnet;

FIG. 8 is a diagram illustrating another exemplary environment in which embodiments may be implemented,

FIG. 9 is an illustration of a single Network Slice Selection Assistance Information (S-NSSAI) configuration including a slice anti-affinity (SA) parameter, according to an implementation,

FIG. 10 is a flow diagram illustrating an exemplary process for configuring SA parameter information on a CU;

FIG. 11 is a flow diagram illustrating an exemplary process for instantiating a network slice using SA designations; and

FIG. 12 is a diagram illustrating exemplary components of a device that may be included in one or more of the devices described herein.

### DETAILED DESCRIPTION

The following detailed description refers to the accompanying drawings. The same reference numbers in different drawings may identify the same or similar elements. Also, the following detailed description does not limit the invention.

The evolution of mobile networks, such as Next Generation radio networks, towards open Radio Access Networks (RANs) and virtualized RANs has gained momentum. Open RANs have the ability to integrate, deploy, and operate RANs using elements (e.g., components, subsystems, and software) which are sourced from multiple different vendors, are inter-operable, and can connect over open interfaces. Virtualized RANs involve the use of Network Functions Virtualization (NFV) and Software Defined Networks (SDNs) to virtualize a portion of the RAN onto standard Information Technology (IT) and Commercial Off-the-Shelf (COTS) hardware in a central location or in the cloud. For example, in one implementation, functions of a single base station (e.g., a next generation node-B, or gNB) may be provided through one or more central units (CUs) supported by multiple distributed units (DUs) and radio units (RUs). Virtualized RANs offer advantages, including a flexible and scalable architecture that enables dynamic load-balancing, intelligent traffic steering, and latency reduction using local caching.

Next Generation mobile networks, through the use of network slicing, for example, are being designed to offer a variety of services that each demands a different network performance for different types of transport sessions. However, in current virtualized RAN configurations, multiple RAN slices may share the same network function (NF) resources, and network operators (e.g., mobile network operators or MNOs) do not always have control of certain NF features. For example, multiple slices may use the same CU resources, but MNOs may not be able to separate, prioritize, or isolate RAN slice traffic at the CUS. There remains a need to separate, prioritize, or isolate RAN slice traffic among CUs within the same or different cell sites. Furthermore, it is desirable to dynamically change performance metrics of an existing RAN slice using the same CU based on user needs.

Systems and methods described herein provide new parameters for RAN configurations to manage network slices. According to an embodiment, a new parameter (referred to herein as a “mode” parameter) is provided for CU configurations to allow for a user to experience enhanced slice performance without changing the slice. The mode parameter provides additional control for operators to steer network slices into different CUs located in the same or different cell sites. Modes can be based on CU capacity, CU location, CU architecture, or combinations thereof and can be managed by the MNO. Use of the mode parameters can reduce overall RAN costs and required configuration intelligence.

According to another embodiment, a new parameter (referred to herein as a “slice anti-affinity” (SA) parameter) is provided to better enable isolation of slices at a NF level. The SA parameter may be included, for example, in single Network Slice Selection Assistance Information (S-NSSAI). Network slices may be assigned to different NFs based on the SA parameter. The SA parameter may be used to increase system reliability and security by improving isolation of network slices at the NF level. For example, if the SA parameter is set to true for an S-NSSAI, the corresponding network slice can only be configured in NFs that do not already host other slice configurations.

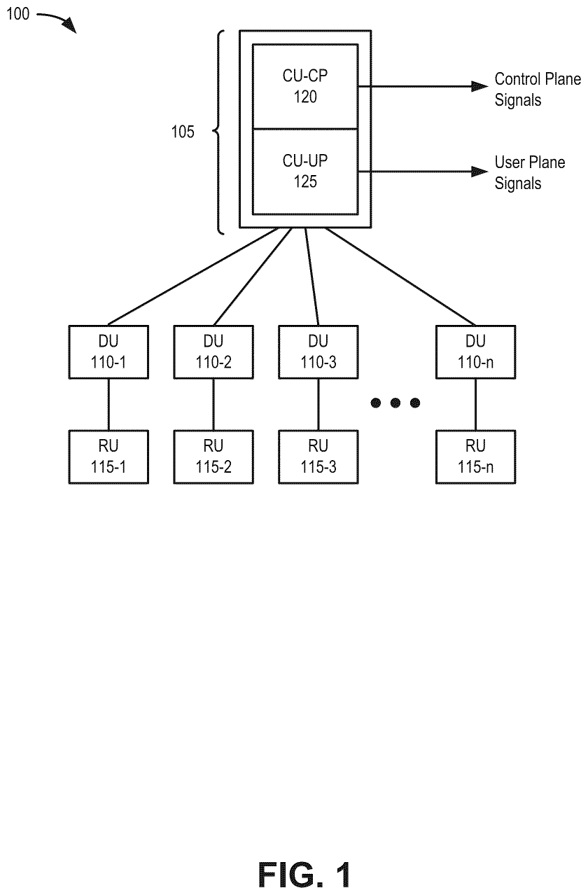

FIG. 1 illustrates the implementation of an exemplary base station 100 of a wireless network (not shown). The base station 100 may, in one implementation, include a gNB used in the RAN of a Next Generation mobile network, such as, for example, a 5G mobile network. Base station 100 may include a CU 105, at least one DU 110, and at least one RU 115. As shown, CU 105 may be divided into two subcomponents: a CU-Control Plane (CP) component 120 (referred to herein as “CU-CP 120”) and a CU-User Plane (UP) component 125 (referred to herein as “CU-UP 125”). The CU-CP 120 includes a logical node that hosts Radio Resource Control (RRC), and other control plane, functions (e.g., Service Data Adaptation Protocol (SDAP), and Packet Data Convergence Protocol (PDCP)). The CU-CP 120 may additionally perform a radio slice steering, as described further herein. CU-CP 120 may select a particular CU-UP 125, for routing and transporting data to and from user equipment (UE) for a given data session based on, for example, a mode parameter, along with performance profiles and/or network performance requirements associated with a data session.

The CU-UP 125 includes a logical node that hosts user plane functions, such as, for example, data routing and transport functions. As described in further detail below, CU-CP 120 and CU-UP 125 of CU 105 may include distributed nodes that may be located remotely from one another. As further described below, multiple distributed CU-CP 120s and/or multiple CU-UPs 125 may be positioned at different locations within a network (not shown). A selected one of the CU-CPs 120 and a selected one of the CU-UPs 125 may be used for handling traffic from one or more UEs (not shown).

The DU 110 of base station 100 may, in some implementations, include multiple DUs 110-1 through 110-n. Each DU 110 of the multiple DUs includes a logical node that hosts functions associated with the Radio Link Control layer, the Medium Access Control (MAC) layer, and the physical layer (PHY). The RU 115 may include multiple RUs 115-1 through 115-n. Each RU 115 may include at least one radio transceiver, and associated antenna(s), for RF wireless communication with one or more UEs (not shown). Each DU 110 connects to a RU 115. For example, each DU of the multiple DUs 110-1 through 110-n connects to a respective one of RUs 115-1 through 115-n (e.g., DU 110-1 connects to RU 115-1, DU 110-2 connects to RU 115-2, etc.).

CU 105 controls the transport of data (e.g., data packets) received at a RU 115 via wireless RF transmissions from a UE (not shown in FIG. 1), and controls the transport of data from the wireless network to a DU 110 and RU 115 for wireless transmission to a destination UE (not shown).

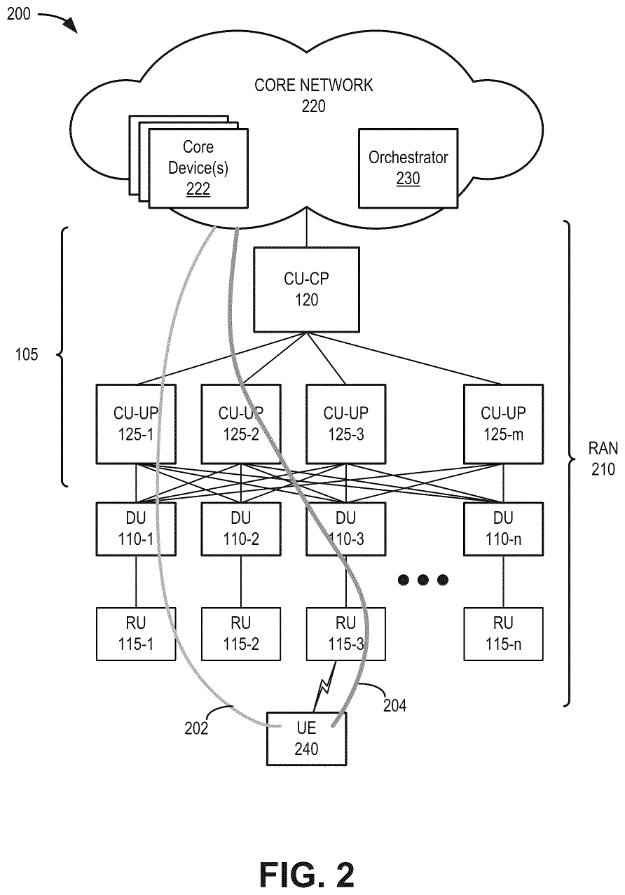

FIG. 2 illustrates examples of data transport to and from a UE in a mobile network environment 200 with multiple distributed CU-UPs 120. Network environment 200 may include a RAN 210 and a core network 220 to which a UE 240 connects via wireless or wired links.

RAN 210 may include various types of radio access equipment that implement Radio Frequency (RF) communication with UEs 240. The radio access equipment of RAN 210 may include, for example, multiple DUs 110 and RUs 115 and a CU 105 including multiple CU-UPS 125 and at least one CU-CP 120. Only a single CU 105 is shown in FIG. 2, however, RAN 210 may include multiple CUs 105. RAN 210 may additionally include other nodes, functions, and/or components not shown in FIG. 2. RAN 210 may support a portion (referred to herein as a subnet) of an end-to-end network slice that includes additional NFs in core network 220 and elsewhere.

Core network 220 includes devices or nodes that implement NFs including, among other NFs, mobile network access management, session management, and policy control NFs. Depending on the implementation of core network 220, core network 220 may include diverse types of network devices that are illustrated in FIG. 2 as core devices 222. For example, core devices 222 may include an access and mobility management function (AMF), a user plane function (UPF), a session management function (SMF), a network slice selection function (NSSF), and a policy control function (PCF). According to other exemplary implementations, core devices 222 may include additional, different, and/or fewer network devices than those described herein.

Core network 220 may also include a slice orchestrator 230. Slice orchestrator 230 may perform, among other operations and functions, network slice and network slice instance creation, virtual network resource allocation, instantiation, and provisioning, and network slice monitoring, reporting, and life cycle management (LCM). Slice orchestrator 230 may provide network slice instance and network slicing configuration information to core devices 222, such as an NSSF. According to an implementation, core devices 222 and slice orchestrator 230 may be implemented as Virtual Network Functions (VNFs) within core network 220 or another network.

UE 240 may include any type of electronic device having a wireless capability (e.g., a RF transceiver) to communicate with the wireless network via a base station 100. Each UE 240 may include, for example, a computer (e.g., desktop, laptop, tablet, or wearable computer), a personal digital assistant (PDA), a “smart” phone, a vehicle-to-everything (V2X) device, or a “Machine-to-Machine” (M2M) or “Internet of Things” (IoT) device. A “user” (not shown) may own, operate, and/or administer each UE 240.

Each network slice may include its own dedicated or shared set of NFs, where each NF operates to service UE sessions handled by that particular network slice. Each network slice may be assigned a Single-Network Slice Selection Assistance Information (S-NSSAI) value that uniquely identifies the network slice. The S-NSSAI value may, for example, include a Slice/Service Type (SST) value and a Slice Differentiator (SD) value (e.g., S-NSSAI=SST+SD). The SST may define the expected behavior of the network slice in terms of specific features and services. The SD value may be directly related to the SST value and may be used as an additional differentiator (e.g., if multiple network slices carry the same SST value). The S-NSSAI may be used within a mobile network for network slice selection for servicing UE sessions.

In the configuration of FIG. 2, CU 105 may include CU-CP 120 and multiple CU-UPs 125, including CU-UP 125-1 through CU-UP 125-m. Data may be transported to and from UE 240 via a selected CU-UP 125 and a selected DU 110. CU-CP 120 may select a certain CU-UP 125 and DU 110 to, for example, balance network loads and optimize network slicing. For example, to meet a certain network slice requirements CU-CP 120 may select CU-UP 125-1 and DU 110-1 for data transport between UE 240 and a destination UE or other destination network node (e.g., a server), as shown by a slice subnet 202 path. As a further example, CU-CP 120 may select CU-UP 125-2 and DU 110-3 for data transport between UE 240 and a destination UE, or other destination network node, as shown by slice subnet 204 path. According to an implementation described herein, network slices may be configured with a new mode parameter to influence how traffic is steered from one CU-UP 125 to another CU-UP 125. Depending on the mode parameter, performance values (e.g., key performance indicators or KPIs, such as latency, throughput, etc.) for a session can be improved without the need for changing network slices.

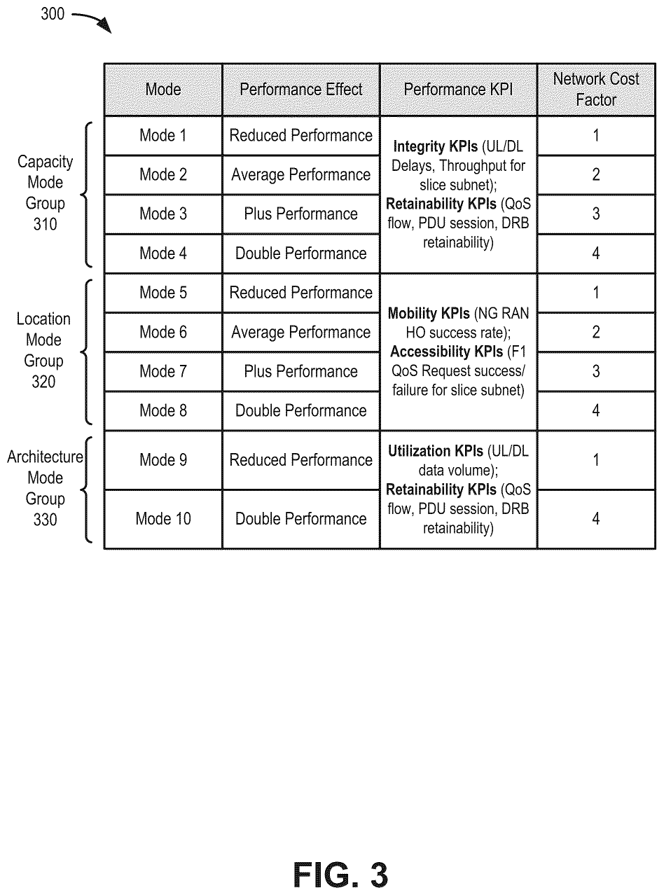

FIG. 3 is a table 300 illustrating an example of different mode groupings and modes that may be applied to a CU 105. As shown in FIG. 3, modes 1-4 may be capacity modes 310, modes 5-8 may be location modes, and modes 9 and 10 may be architecture modes. While a total of ten modes are shown in table 300, there may be a different number of modes used in other implementations or different combinations of modes.

Capacity modes 310 may be an indication of CU capacity. CU capacity can be measured in different criteria such as compute, storage, network, or number of connections it is facilitating (the true nature or functionality of a network element). Capacity modes 310 can refer to any of the above criteria. While every CU 105 has a limit (e.g., a capacity limit), capacity modes 310 (e.g., modes 1-4) are used to dimension the CU capacity into sections. The CU dimensioning may be structured either vertically or horizontally. For example, if a limit for mode 1 is exceeded, other mode 1 sections (e.g., Mode 1-1, Mode 1-2, Mode 1-3) can be created to facilitate additional load.

Each of capacity modes 310 may provide a performance level relative to a configured/design performance KPI for a subnet of a network slice. For capacity modes 310, performance KPIs may include integrity KPIs (e.g., uplink (UL)/downlink (DL) delays or throughput for the slice subnet) or retainability KPIs (e.g., quality of service (QoS) flow, protocol data unit (PDU) session, or dedicated radio bearer (DRB) retainability). For example, mode 1 may provide a reduced performance level (e.g., a factor of 0.2 times a designed slice KPI), mode 2 may provide the average (or expected) performance level (e.g., equal to the designed slice KPI), mode 3 may provide a plus performance level (e.g., a factor of 1.5 times the designed slice KPI), and mode 4 may provide a double performance level (e.g., a factor of 2 times the designed slice KPI).

A cost factor may be associated with each of capacity modes 310. For example, mode 1 may have the lowest cost factor (e.g., 1) of the capacity modes 310, while mode 4 may have the highest cost factor (e.g., 4). The cost factor may provide a mechanism for mode selection via machine learning and/or artificial intelligence.

Location modes 320 may be an indication of CU location (e.g., distance from an end user). CU location can be measured, for example, based on geographic distance or physical network link distance to a user, where shorter distances generally correspond to lower latency. Location modes 320 (e.g., modes 5-8) are used to dimension the CU locations into sections. In the example of FIG. 3, mode 5 may represent a farthest link distance, while mode 8 may represent a closest link distance. Generally, shorter link distances may provide for lower latency.

Each of location modes 320 may provide a performance level relative to a performance KPI for a subnet of a network slice. For location modes 320, performance KPIs may include mobility KPIs (e.g., NG RAN handover (HO) success rate) or accessibility KPIs (e.g., F1 interface QoS Request success/failure for slice subnet). For example, mode 5 may provide a reduced performance level (e.g., a factor of 0.2 times a designed slice KPI), mode 6 may provide the average (or expected) performance level (e.g., equal to the designed slice KPI), mode 7 may provide a plus performance level (e.g., a factor of 1.5 times the designed slice KPI), and mode 8 may provide a double performance level (e.g., a factor of 2 times the designed slice KPI). Similar to capacity modes 310, a cost factor may be associated with each of location modes 320. For example, mode 5 may have the lowest cost factor (e.g., 1) of the location modes 320, while mode 8 may have the highest cost factor (e.g., 4).

Architecture modes 330 may be an indication of CU redundancy (e.g., multiple peer CU-UPs 125). For example, a CU 105 may be configured with a peer-to-peer (P2P) network architecture. Each of architecture modes 330 may provide a performance level relative to a performance KPI for a subnet of a network slice. For architecture modes 330, performance KPIs may include utilization KPIs (e.g., UL/DL data volume) or retainability KPIs (e.g., QoS flow, PDU session, DRB retainability). For example, mode 9 may provide a reduced performance level (e.g., a factor of 0.2 times a designed slice KPI) and mode 10 may provide a double performance level (e.g., a factor of 2 times the designed slice KPI). Similar to capacity modes 310 and location modes 320, a cost factor may be associated with each of architecture modes 330. For example, mode 9 may have a low cost factor (e.g., 1), while mode 10 may have a high cost factor (e.g., 4).

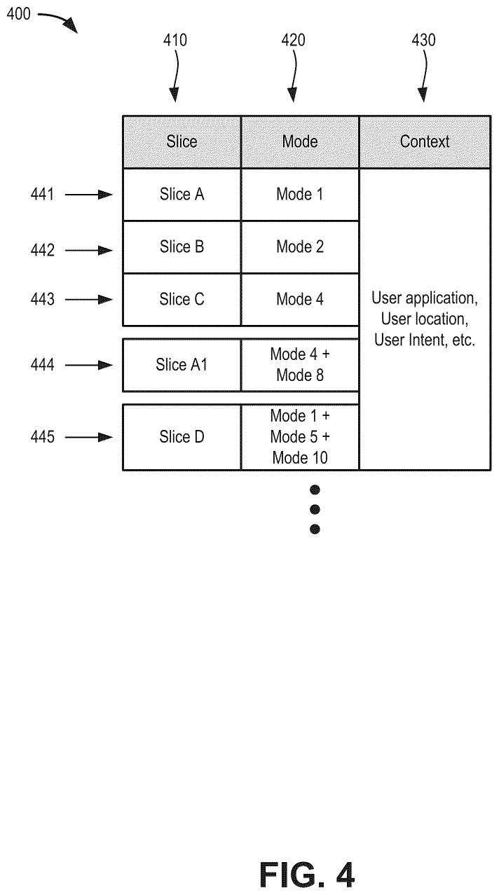

FIG. 4 is a table 400 illustrating example associations of a network slice to a mode. Table 400 may include a slice field 410, a mode field 420, a context field 430, and a variety of entries 441-445. Table 400 is a simplified example of mode parameters that may be used in network slice configuration.

As shown in FIG. 4, slice field 410 may include a slice identifier, which may include a network slice's S-NSSAI or another network slice identifier, shown in FIG. 4 simply as “Slice A,” “Slice B,” etc. Mode field 420 may include a mode indicator, such as mode 1, mode 2, mode 3, etc., corresponding to modes described in FIG. 3, for example. According to an implementation, any of ten or more different modes may be assigned to a network slice, in addition to combinations of modes in different groups. For example, a combination of modes from different groups based on CU capacity, CU location, and CU architecture may be assigned to a single network slice.

Modes may be associated with a network slice during network slice design and/or after deployment. An assigned mode may be used, for example, alter or enhance the slice performance (or user experience) without changing the slice.

In table 400, entry 441 associates Slice A with Mode 1, which (according to table 300) would reduce slice performance to as low as 0.2 times a designed capacity-based KPI for Slice A. Entry 442 associates Slice B with Mode 2, which would keep slice performance at a designed capacity-based KPI for Slice B. Entry 443 associates Slice C with Mode 4, which would increase slice performance to double a designed capacity-based KPI for Slice C.

In another implementation, entry 444 associates Slice A1 with both a capacity mode (i.e., Mode 4) and a location mode (i.e., Mode 8), which (according to table 300) would increase slice performance to double a designed capacity-based KPI for Slice A1 and increase slice performance to double a designed location-based KPI for Slice A1. In still another implementation, entry 445 associates Slice D with Mode 1, Mode 5, and Mode 10, which (according to table 300) would reduce slice performance to as low as 0.2 times a designed capacity-based KPI for Slice D, and reduce slice performance to as low as 0.2 times a designed location-based KPI for Slice D, and increase slice performance to double a designed architecture-based KPI for Slice D. Other combinations of modes than those illustrated in FIG. 4 may be used.

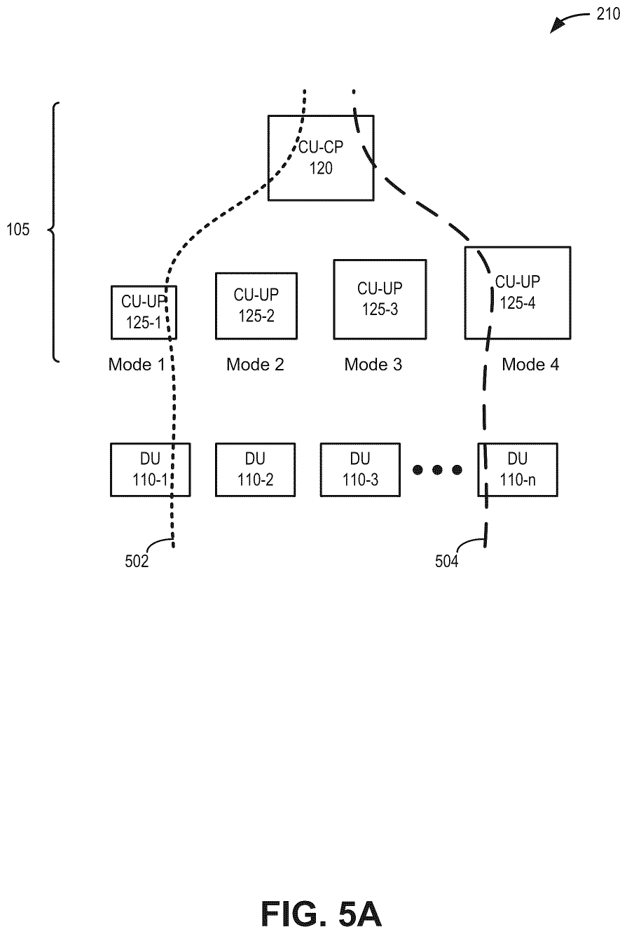

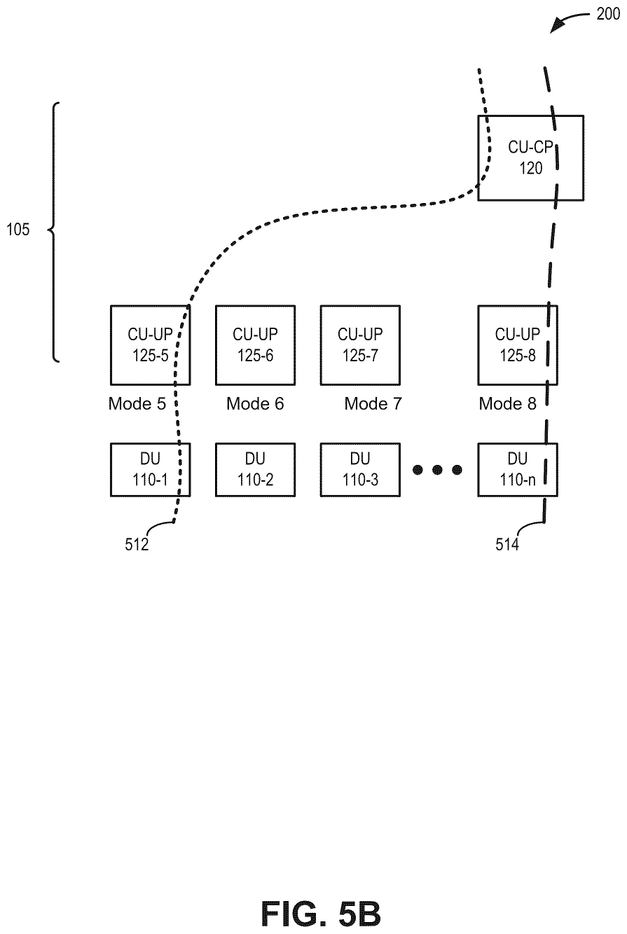

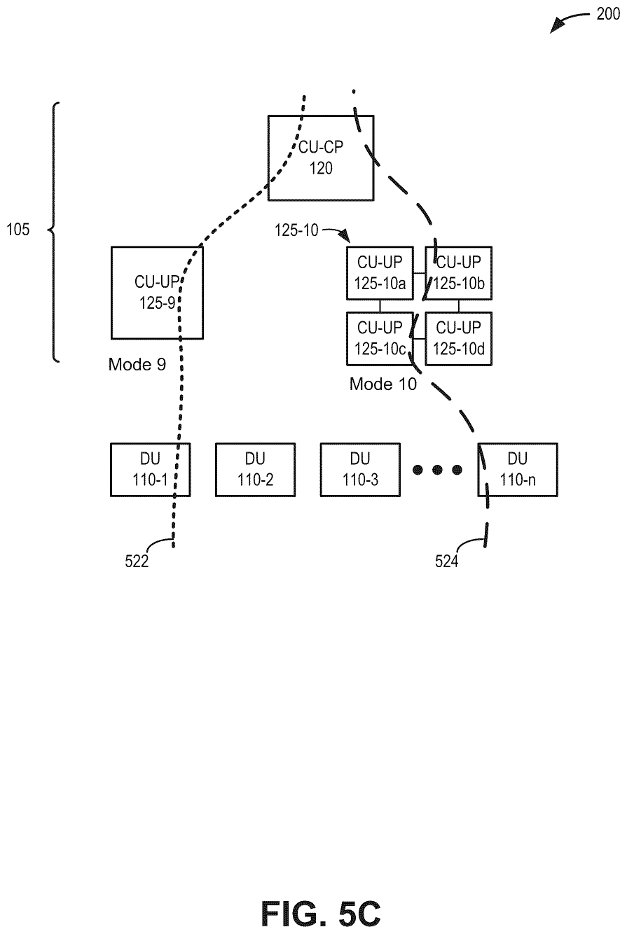

FIGS. 5A-5C illustrate application of different modes to a network slice in CU 105 of RAN 210. In the example of FIG. 5A, capacity modes 310 may be applied to a network slice. CU-UP 125-1 through CU-UP 125-4 may have different capacities. When a network slice is associated with mode 1, the network slice may be configured to utilize a small-capacity CU-UP 125-1, as illustrated in slice subnet 502 path. Use of CU-UP 125-1 may provide reduced network slice performance over the slice design parameters. CU-UP 125-1 may guarantee, for example, 0.2 times a capacity-based KPI (e.g., throughput through RAN 210) for the network slice. Conversely, when the same network slice is associated with mode 4, the network slice may be configured to utilize a largest-capacity CU-UP 125-4, as illustrated in slice subnet 504 path. Use of CU-UP 125-4 may provide improved network slice performance over the slice design parameters. CU-UP 125-4 may guarantee, for example, double the capacity-based KPI (e.g., throughput through RAN 210) for the network slice.

In the example of FIG. 5B, location modes 320 may be applied to a network slice. CU-UP 125-5 through CU-UP 125-8 may be in different locations. When a network slice is associated with mode 5, the network slice may be configured to utilize a farther distance CU-UP 125-5, as illustrated in slice subnet 512 path. Use of CU-UP 125-5 may provide reduced network slice performance over the slice design parameters. CU-UP 125-5 may guarantee, for example, 0.2 times a location-based KPI (e.g., RAN HO success rate) for the network slice. Conversely, when the same network slice is associated with mode 8, the network slice may be configured to utilize a nearest CU-UP 125-8, as illustrated in slice subnet 514 path. Use of CU-UP 125-8 may provide improved network slice performance over the slice design parameters. CU-UP 125-8 may guarantee, for example, double the location-based KPI (e.g., RAN HO success rate) for the network slice.

In the example of FIG. 5C, architecture modes 330 may be applied to a network slice. In FIG. 5C, CU-UP 125-10 may include a peer-to-peer network that allows downloads or uploads from multiple CP-UP instances (e.g., CU-UP 125-10a through 125-10d). Use of multiple CP-UP instances may in turn use multiple PDU sessions. When a network slice is associated with mode 9, the network slice may be configured to utilize a CU-UP 125-9 (e.g., a single CU-UP instance), as illustrated in slice subnet 522 path. CU-UP 125-9 may provide reduced network slice performance over the slice design parameters, such as 0.2 times an architecture-based KPI (e.g., UL/DL data volume) for the network slice. Conversely, when the same network slice is associated with mode 10, the network slice may be configured to utilize CU-UP 125-10, as illustrated in slice subnet 524 path. Use of CU-UP 125-10 may provide improved network slice performance over the slice design parameters, such as, double the location-based KPI (e.g., UL/DL data volume) for the network slice.

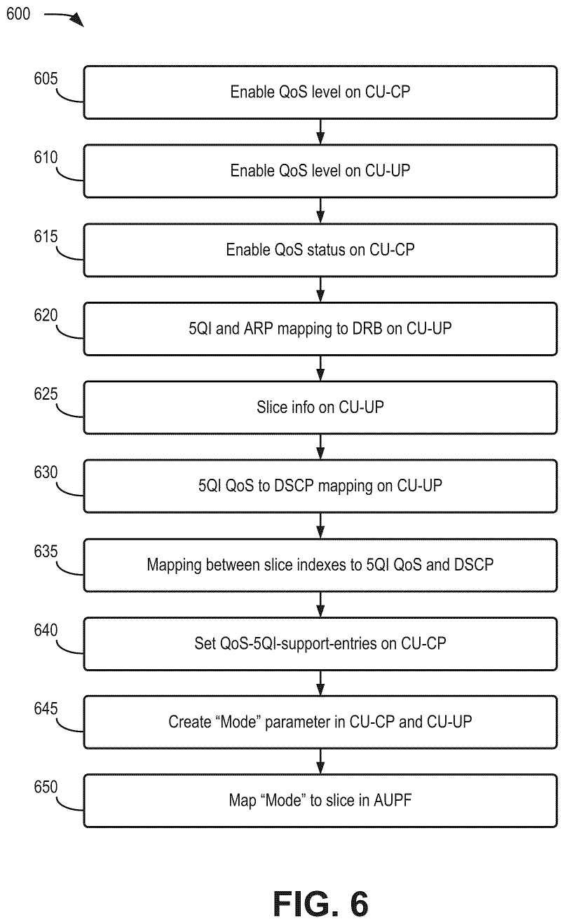

FIG. 6 is a flow diagram illustrating an exemplary process 600 for configuring a CU according to an implementation described herein. In one implementation, process 600 may be performed as a design-time configuration with the configuration implemented on a node (e.g., CU-UP 125) at run-time.

Process 600 may include blocks 605-640, which may be consistent with a conventional CU configuration. For example, process 600 may include enabling a QoS level (e.g., a certain 5G QoS identifier (5Q1)) on a CU-CP (block 605), and enabling the 5QI status on the CU-CP (block 615). Additionally, 5QI and Allocation and Retention Priority (ARP) are mapped to a DRB on the CU-UP (block 620) and slice information is provisioned on the CU-UP (block 625). Process 600 may further include 5QI QoS to Differentiated Services Code Point (DSCP) mapping on the CU-UP (block 630). The associated UPF (e.g., implemented in one of core devices 220) may perform the mapping between slice indexes to 5QI QoS and DSCP (block 635) and QoS-5QI-support-entries can be set on the CU-CP (block 640).

In addition to the conventional CU configuration steps, process 600 may additionally include creating mode parameter(s) in the CU-CP and CU-UP (block 645). For example, one or more of a capacity mode 310, a location mode 320, or an architecture mode 330 may be designated for a CU-CP 120/CU-UP 125 combination based on the CU 105 capacity, location, architecture, and/or other characteristics. Process 600 may further include mapping the mode to a slice in the associated UPF (block 650). For example, an Application Control and Policy Function (ACPF) may map the assigned mode to the slice in the UPF via an E1 interface.

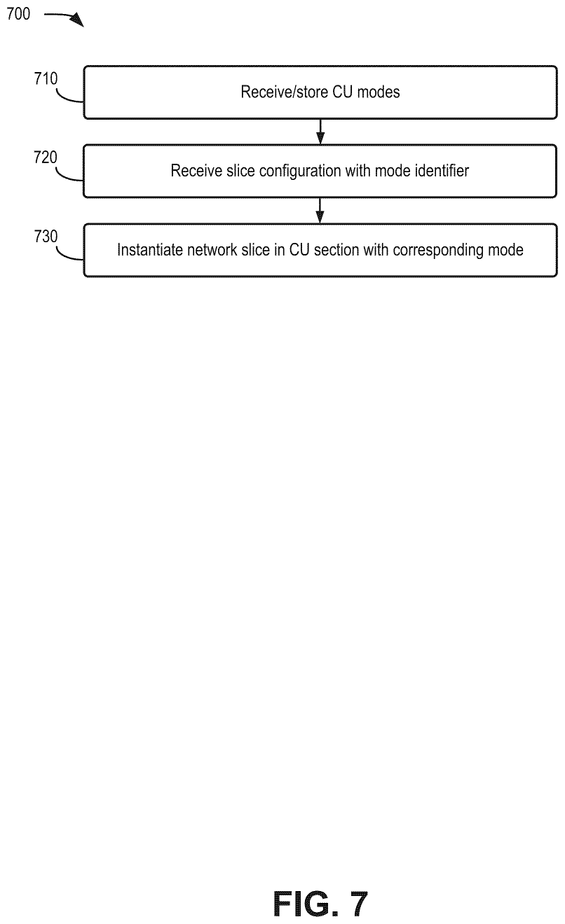

FIG. 7 is a flow diagram illustrating a process 700 for instantiating a network slice using mode designations in a RAN subnet. According to an implementation, process 700 may be performed, for example, by a CU 105. In other implementations, process 700 may be performed by CU 105 in conjunction with one or more other devices or functions in environment 200.

Process 700 may include receiving and storing CU modes (block 710) and receiving a slice configuration with a mode identifier (block 720). For example, CU 105 may be configured to store definitions for multiple modes. Each mode may define a section of the CU (e.g., CU-UP 125) that provides a relative performance level for RAN 210. The relative performance level may relate to a KPI for capacity through the RAN subnet, latency over the RAN subnet, or architecture of the RAN subnet. CU 105 may receive a slice configuration request for a network slice that identifies a mode or a combination of modes.

Process 700 may further include instantiating the network slice in a CU section with the corresponding mode (block 730). For example, CU-CP 120 may instantiate the network slice to operate over the section of CU-UP 125 that is associated with the identified mode (or mode combination) for the slice. The selected mode may be configured to provide reduced performance, average performance, improved performance relative to a designed slice performance, for the network slice over the RAN subnet. Each of modes may include a corresponding cost-factor for implementation, which CU-CP 120 may apply to balance mode selection/allocation among different CU-UPs 125.

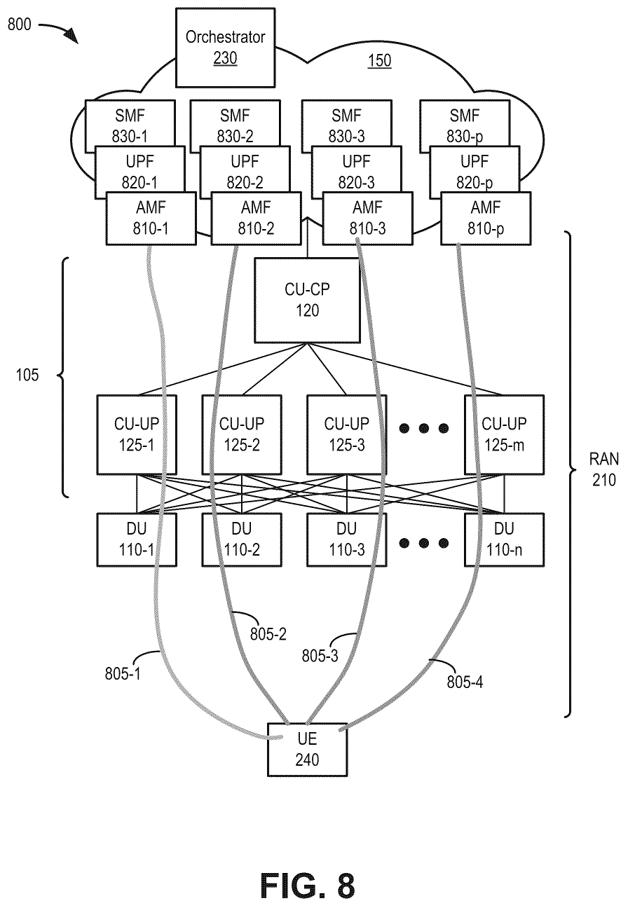

FIG. 8 illustrates examples of data transport to and from a UE in a mobile network environment 800 with multiple distributed CU-UPs and core network functions. Network environment 800 may include RAN 210, core network 220 and UE 240. In the example of FIG. 8, core network 240 may include multiple distributed AMFs 810-1 through 810-p (generically referred to as AMFs 810), UPFs 820-1 through 820-p (generically referred to as UPFs 820), and SMFs 830-1 through 830-p (generically referred to as SMFs 830). Each of AMF 810, UPF 820, and SMF 830 may be implemented on core devices 222.

In the configuration of FIG. 8, data may be transported to and from UE 240 via network slices 805-1 through 805-4 that each includes a selected DU 110, CU-UP 125, AMF 810, UPF 820, and SMF 830. Each network slice 805-1 through 805-4 (referred to collectively as slices 805) may include a logical end-to-end network, which may run on a shared physical infrastructure, that is created to serve a particular purpose and/or service data traffic (e.g., of particular applications) with a particular set of performance parameters or characteristics. For example, each network slice of network slices 805-1 through 805-4 may service a particular service type and/or may satisfy or meet particular network performance requirements for sessions served by the network slice. In some implementations, each network slice may have a different SST, such as, for example, an enhanced Mobile Broadband (eMBB) SST, an Ultra Reliable Low Latency Communications (URLLC) SST, or a Massive Internet of Things (mIoT) SST.

According to an implementation described herein, each of network slices 805 may be configured with a new slice anti-affinity (SA) parameter to enable isolation of slices at a NF level. Accordingly, a DU 110, CU-UP 125, AMF 810, UPF 820, SMF 830, or another supervisory network function (e.g., slice orchestrator 230) may be configured to read and interpret the new SA parameter. According to an implementation, the SA parameter may be included, for example, in the S-NSSAI that UE 240 provides, to core network 220, when requesting a network connection. Using the SA parameter may allow the RAN 210/core network 220 to more efficiently allocate resources. For example, high-network-cost resources, such as CUs 105 that are collated with DUs 110, may be reserved for low latency and high reliability slices. Similarly, a high reliability slice may take advantage of access to SA-designated resources and multiple CU locations for reliability and redundancy.

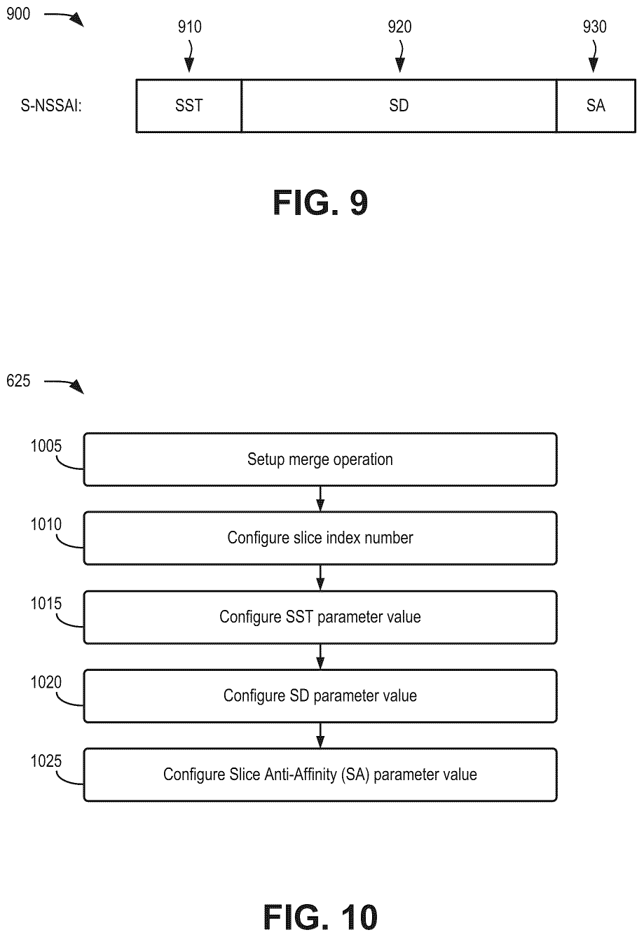

FIG. 9 is an illustration of S-NSSAI configuration 900 including an SA parameter. As described above in connection with FIG. 2, a S-NSSAI typically includes an 8-bit SST (shown in FIG. 9 as SST 910) and a 24-bit SD (shown in FIG. 9 as SD 920). According to an implementation described herein, the structure of the S-NSSAI may be modified to further include an additional 1-bit SA indicator 930. In one implementation, SA indicator 930 may be concatenated at the end of SD 920.

SA indicator 930 may include, for example, a toggle indication (e.g., 1=True, 0=False) for whether SA is applicable to a requested network slice. If the SA parameter is true, the slice cannot be configured in NFs that already hosts other slice configurations. Thus, the SA parameter may be used to isolate one network slice from another.

Although FIG. 9 provides an example of how an SA parameter may be included in S-NSSAI, in other implementations, the SA parameter may be included in a different portion of the S-NSSAI or separate from the S-NSSAI.

FIG. 10 is a flow diagram illustrating a process 1000 for configuring SA parameters on a CU. Process 1000 may correspond to process block 625 of FIG. 6. More particularly, process block 625 may be modified to incorporate provisioning of an SA parameter, as described herein. In one implementation, process 1000 may be performed as a design-time configuration with the configuration implemented on a node (e.g., CU-UP 125) at run-time.

Process 1000 may include blocks 1005-1020, which may be consistent with a conventional CU configuration step for provisioning slice information on a CU-UP. For example, process 1000 may include setting up a merge operation for configured values (block 1005) and configuring a slice index number (block 1010). Process 1000 may also include configuring a placeholder for an SST value for the network slice (block 1015), and configuring a placeholder for a SD value for the network slice (block 1020).

Process 1000 may further include configuring a placeholder for an SA value for the network slice (block 1025). For example, CU-UP 125 may be configured to receive a single-bit indicator for SA parameter 930 (e.g., 1=True, 0=False) based on whether SA is applicable to the corresponding network slice.

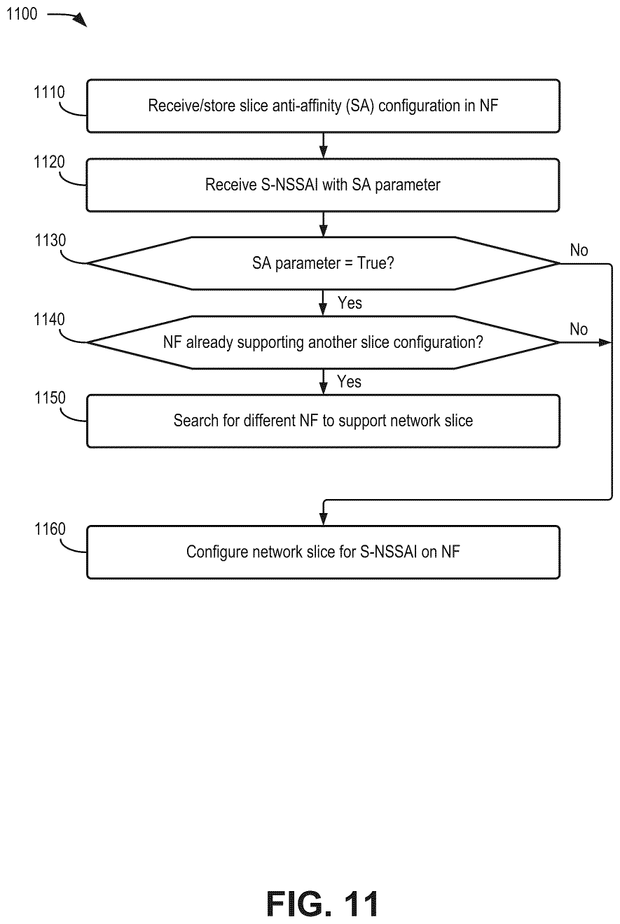

FIG. 11 is a flow diagram illustrating a process 1100 for instantiating a network slice using SA designations. According to an implementation, process 1100 may be performed, for example, by a NF, such as CU-UP 125, AMF 810, UPF 820, or SMF 830. In other implementations, process 1100 may be performed by CU-CP 120 or orchestrator 230 in conjunction with one or more other devices or functions in environment 800.

Process 1100 may include receiving and storing a SA configuration in a NF (block 1110), receiving a S-NSSAI with an SA parameter (block 1120), and determining if the SA parameter is true (block 1130). For example, a NF, such as CU-UP 125, AMF 810, UPF 820, or SMF 830, may be configured to store definitions for an SA parameter. The SA parameter may define whether more than one slice can be configured on an NF. After the NF is configured to detect and act on an SA parameter, slice orchestrator 230 or CU-CP 120 may receive S-NSSAI with an SA parameter.

If the SA parameter is true (block 1130—Yes), process 1100 may include determining if the NF is already supporting another slice configuration (block 1140). For example, slice orchestrator 230 or CU-CP 120 may query whether another slice is being hosted by the NF and receive slice information for that slice.

If the NF is already supporting another slice configuration (block 1140—Yes), process 1110 may include searching for a different NF(s) to support the requested network slice (block 1150). For example, slice orchestration 230 may query other available NFs to support the requested network slice.

If the SA parameter is not true (block 1130—No) or if the NF is not already supporting another slice configuration (block 1140—No), process 1110 may include configuring the network slice for the S-NSSAI on the NF (block 1160). For example, if the is no active SA setting or if no other slice is configured on the NF, the NF may be used to support the network slice for the S-NSSAI.

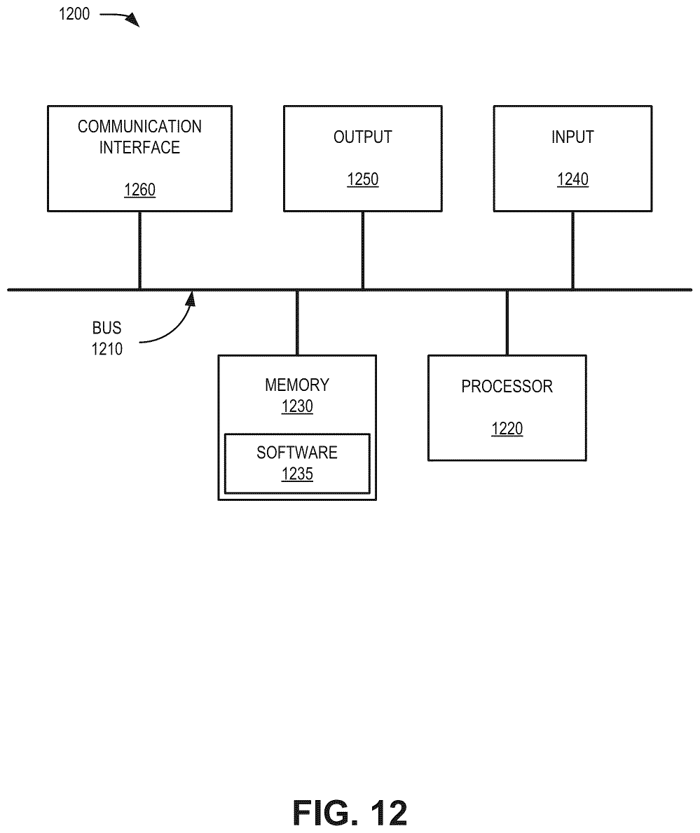

FIG. 12 is a diagram illustrating exemplary components of a device 1200 that may be included in one or more of the devices described herein. For example, device 1200 may correspond to elements of a wireless station (e.g., CU 105, DU 110, CU-CP 120, CU-UP 125, etc.), core device 222, UE 240, AMF 810, UPF 820, or SMF 830, and/or other types of network devices, as described herein. As illustrated in FIG. 12, device 1200 includes a bus 12010, a processor 1220, a memory/storage 1230 that stores software 1235, an output 1240, an input 1250, and a communication interface 1260. According to other embodiments, device 1200 may include fewer components, additional components, different components, and/or a different arrangement of components than those illustrated in FIG. 12 and described herein.

Bus 1210 includes a path that permits communication among the components of device 1200. For example, bus 1210 may include a system bus, an address bus, a data bus, and/or a control bus. Bus 1210 may also include bus drivers, bus arbiters, bus interfaces, clocks, and so forth.

Processor 1220 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 1220 may be implemented as hardware (e.g., a microprocessor, etc.), a combination of hardware and software (e.g., a SoC, an ASIC, etc.), may include one or multiple memories (e.g., cache, etc.), etc.

Processor 1220 may control the overall operation or a portion of operation(s) performed by device 1200. Processor 1220 may perform one or multiple operations based on an operating system and/or various applications or computer programs (e.g., software 1235). Processor 1220 may access instructions from memory/storage 1230, from other components of device 1200, and/or from a source external to device 1200 (e.g., a network, another device, etc.). Processor 1220 may perform an operation and/or a process based on various techniques including, for example, multithreading, parallel processing, pipelining, interleaving, etc.

Memory/storage 1230 includes one or multiple memories and/or one or multiple other types of storage mediums. For example, memory/storage 1230 may include one or multiple types of memories, such as, a random access memory (RAM), a dynamic random access memory (DRAM), a static random access memory (SRAM), a cache, a read only memory (ROM), a programmable read only memory (PROM), an erasable PROM (EPROM), an electrically EPROM (EEPROM), a single in-line memory module (SIMM), a dual in-line memory module (DIMM), a flash memory, a solid state memory, and/or some other type of memory. Memory/storage 1230 may store data, software, and/or instructions related to the operation of device 1200.

Software 1235 includes an application or a program that provides a function and/or a process. Software 1235 may also include firmware, middleware, microcode, hardware description language (HDL), and/or other form of instruction. Software 1235 may also be virtualized. Software 1235 may further include an operating system (OS) (e.g., Windows, Linux, Android, proprietary, etc.).

Communication interface 1260 permits device 1200 to communicate with other devices, networks, systems, and/or the like. Communication interface 1260 includes one or multiple wireless interfaces and/or wired interfaces. For example, communication interface 1260 may include one or multiple transmitters and receivers, or transceivers (e.g., RF transceivers). Communication interface 1260 may operate according to a protocol stack and a communication standard. Communication interface 1260 may include an antenna. Communication interface 1260 may include various processing logic or circuitry (e.g., multiplexing/de-multiplexing, filtering, amplifying, converting, error correction, API, etc.). Communication interface 1260 may be implemented as a point-to-point interface, a service-based interface, or a reference interface, for example.

Input 1240 permits an input into device 1200. For example, input 1240 may include a keyboard, a mouse, a display, a touchscreen, a touchless screen, a button, a switch, an input port, speech recognition logic, and/or some other type of visual, auditory, tactile, etc., input component. Output 1250 permits an output from device 1200. For example, output 1250 may include a speaker, a display, a touchscreen, a touchless screen, a light, an output port, and/or some other type of visual, auditory, tactile, etc., output component.

As previously described, a network device may be implemented according to various computing architectures (e.g., in a cloud, edge, etc.) and according to various network architectures (e.g., a virtualized function, etc.). Device 1200 may be implemented in the same manner. For example, device 1200 may be instantiated, created, deleted, or obtain some other operational state during its life-cycle (e.g., refreshed, paused, suspended, rebooting, or another type of state or status), using well-known virtualization technologies (e.g., hypervisor, container engine, virtual container, virtual machine, etc.) in an application service layer network and/or another type of network.

Device 1200 may perform a process and/or a function, as described herein, in response to processor 1220 executing software 1235 stored by memory/storage 1230. For example, instructions may be read into memory/storage 1230 from another memory/storage 1215 (not shown) or read from another device (not shown) via communication interface 1260. The instructions stored by memory/storage 1230 cause processor 1220 to perform a process described herein. Alternatively, for example, according to other implementations, device 1200 performs a process described herein based on the execution of hardware (processor 1220, etc.).

Systems and methods described herein provide new parameters for RAN configurations to manage network slices. According to one implementation, a mode parameter is provided to adjust slice performance within the RAN. A network device stores definitions for multiple mode parameters for a CU of a RAN. Each mode parameter defines a section of the CU that provides a relative performance level for a slice subnet over the RAN. The network device receives a slice configuration request for a network slice that identifies one of the multiple mode parameters and instantiates the network slice to operate over the section of the CU that is associated with the identified one of the multiple mode parameters.

According to another implementation, an SA parameter is provided to selectively isolate network slices and improve slice reliability within the RAN. A network device stores an SA configuration in a NF. The network device receives S-NSSAI with an SA parameter, determines that the SA parameter is true, and determines that the NF already supports another slice configuration. The network device then searches for a different NF to support a network slice based on the S-NSSAI.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration, but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, of blocks have been described with regard to the processes illustrated in FIGS. 6, 7, 10, and 11, the order of the communications and blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 1220) of a device. A non-transitory storage medium includes one or more of the storage mediums described in relation to memory/storage 1230. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, it should be understood that such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method comprising:
storing definitions for multiple mode parameters for a central unit (CU) of a radio access network (RAN), wherein each mode parameter defines a section of the CU that provides a relative performance level for a slice subnet over the RAN;
receiving a slice configuration request for a network slice that identifies one of the multiple mode parameters; and
instantiating the network slice to operate over the section of the CU that is associated with the identified one of the multiple mode parameters.

2. The method of claim 1, wherein the relative performance level relates to a key performance indicator (KPI) for capacity over the slice subnet.

3. The method of claim 2, wherein the KPI includes a compute value, a storage value or a number of connections value.

4. The method of claim 1, wherein the relative performance level relates to a key performance indicator (KPI) for latency over the slice subnet.

5. The method of claim 1, wherein the relative performance level relates to a key performance indicator (KPI) for architecture of the slice subnet.

6. The method of claim 1, wherein the identified one of the multiple mode parameters provides reduced performance, relative to a designed slice performance, for the network slice over the slice subnet.

7. The method of claim 1, wherein the identified one of the multiple mode parameters provides improved performance, relative to a designed slice performance, for the network slice over the slice subnet.

8. The method of claim 1, wherein each of the multiple mode parameters includes a corresponding cost-factor for implementation on the CU.

9. The method of claim 1, wherein the RAN includes at least one CU-control plane (CU-CP) and multiple CU-user-planes (CU-UPs).

10. A network device comprising:
a processor configured to:
store definitions for multiple mode parameters for a central unit (CU) of a radio access network (RAN), wherein each mode parameter defines a section of the CU that provides a relative performance level for a slice subnet over the RAN;
receive a slice configuration request for a network slice that identifies one of the multiple mode parameters; and
instantiate the network slice to operate over the section of the CU that is associated with the identified one of the multiple mode parameters.

11. The network device of claim 10, wherein the relative performance level relates to a combination of at least two of:
a first key performance indicator (KPI) for capacity over the slice subnet,
a second KPI for latency over the slice subnet, or
a third KPI for architecture of the slice subnet.

12. The network device of claim 10, wherein the relative performance level relates to a one or more of:
uplink or downlink delays over the slice subnet,
throughput for the slice subnet, or
protocol data unit (PDU) session retainability for the slice.

13. The network device of claim 10, wherein the identified one of the multiple mode parameters provides reduced performance, relative to a designed slice performance, for the network slice over the slice subnet.

14. The network device of claim 10, wherein the identified one of the multiple mode parameters provides improved performance, relative to a designed slice performance, for the network slice over the slice subnet.

15. The network device of claim 10, wherein each of the multiple mode parameters includes a corresponding cost-factor for implementation on the CU.

16. The network device of claim 10, wherein the network device includes a gNodeB.

17. The network device of claim 10, wherein the network device includes multiple distributed CU-user-planes (CU-UPs).

18. A non-transitory, computer-readable storage medium storing instructions, executable by a processor of a network device, for:
storing definitions for multiple mode parameters for a central unit (CU) of a radio access network (RAN), wherein each mode parameter defines a section of the CU that provides a relative performance level for a slice subnet over the RAN;
receiving a slice configuration request for a network slice that identifies one of the multiple mode parameters; and
instantiating the network slice to operate over the section of the CU that is associated with the identified one of the multiple mode parameters.

19. The non-transitory, computer-readable storage medium of claim 18, wherein the relative performance level relates to a combination of:
a first KPI for capacity over the slice subnet, and
a second KPI for architecture of the slice subnet.

20. The non-transitory, computer-readable storage medium of claim 18, wherein the identified one of the multiple mode parameters provides improved performance, relative to a designed slice performance, for the network slice over the slice subnet.
